(19) United States
(12) Patent Application Publication
(10) Pub. No.: US 2022/0141553 A1
(43) Pub. Date: May 5, 2022

(54) SMART UNDERWATER TRAP MONITORING AND RETRIEVAL SYSTEM

(71) Applicants: Qiaowei Liu, Lianyungang (CN); Zhongyao Sun, Lianyungang (CN); Shiwei Liu, Lehi, UT (US); Lishao Wang, Halifax (CA); Xiaoge Cheng, Beijing (CN)

(72) Inventors: Qiaowei Liu, Lianyungang (CN); Zhongyao Sun, Lianyungang (CN); Shiwei Liu, Lehi, UT (US); Lishao Wang, Halifax (CA); Xiaoge Cheng, Beijing (CN)

(21) Appl. No.: 17/518,646

(22) Filed: Nov. 4, 2021

Related U.S. Application Data
(60) Provisional application No. 63/109,460, filed on Nov. 4, 2020.
(60) Provisional application No. 63/237,799, filed on Aug. 27, 2021.

(51) Int. Cl. H04Q 9/00; A01K 69/06

(52) U.S. Cl. CPC H04Q 9/00; H04W 84/18; A01K 69/06

(57) ABSTRACT

The present disclosure relates to a system for tracking, locating and retrieving fishing traps at sea, the system comprising a plurality of smart trap units and/or trap companion units in communication with a fishing vessel. The fishing vessel has onboard software for tracking the deployment and retrieval of said units, with the data being recorded and uploaded to a network service offering. The units are configured to assist with retrieval of the traps by comprising one or more releasable buoys that may be deployed after a pre-set time or in response to a command signal.

### CROSS REFERENCES TO RELATED APPLICATIONS

The present application claims the benefit and priority of US provisional application no. U.S. 63/109,460, filed 4 Nov. 2020, and of US provisional application no. U.S. 63/237,799, filed 27 Aug. 2021.

### FIELD OF INVENTION

The present invention relates generally to the field of smart underwater traps and trap companion technology. More specifically, the present invention relates to systems and methods for tracking, monitoring, and assisting in the retrieval of fishing equipment and gear.

### BACKGROUND

Abandoned, lost, or discarded fishing gear (ALDFG) is a huge problem in the fishing industry, causing massive expenses to fisheries while having a detrimental impact on underwater ecosystems.

An industry in which this is particularly prevalent is lobster trap fishing, as traps must be left submerged in the sea for long periods of time, are subject to underwater currents, and are labor intensive to check regularly.

The traps are often deployed in groups connected together by rope to a floating buoy above the sea surface to mark the location and it is common for this rope to become tangled with sea floor objects and need to be cut, losing traps. The ropes also form hazards to sea creatures, especially in densely fished areas where large numbers of trapping cages are put into use and there is a resulting high-density of floating cables.

At the same time, the trapping cages, cables, and other equipment thrown into the sea are at risk of being lost due to various circumstances, creating ALDFG which will become marine debris. For example, there is a risk of drift away from the original location of the traps with this setup, leaving entire sets of connected traps lost at sea. There is often little incentive for vessels to retrieve lost traps, with the investment in searching for and retrieving the traps being higher than the cost of buying new ones, particularly since traditional underwater trapping cages do not generate a record of the location and time of their deployment, reducing accountability for marine environment damage.

Another related problem is that traditional underwater trapping cages have an empty cage retrieval rate upwards of 60-70%. This rate greatly reduces the efficiency and increases fishing costs.

It is within this context that the present invention is provided.

### SUMMARY

The present disclosure relates to a system for tracking, locating and retrieving fishing traps at sea, the system comprising a plurality of smart trap units and/or trap companion units in communication with a fishing vessel. The fishing vessel has onboard software for tracking the deployment and retrieval of said units, with the data being recorded and uploaded to a network service offering. The units are configured to assist with retrieval of the traps by comprising one or more releasable buoys that may be deployed after a pre-set time or in response to a command signal.

Thus according to a an aspect of the present disclosure there is provided a system for monitoring and retrieval of one or more fishing traps, the system comprising: a fishing vessel, the fishing vessel comprising a wireless transceiver and a first controller; one or more tracking units, the one or more tracking units comprising a power source, one or more sensors, a wireless transceiver, a buoy connected to an associated fishing trap by a coiled reel, a release mechanism for deploying the buoy and reel, and a second controller; and one or more servers in wireless communication with the first controller and configured to record and log fishing trap management data received from the fishing vessel.

The first controller of the fishing vessel is configured to record deployment and retrieval data from the one or more tracking units, including time and location data of trap deployment, and to upload the deployment and retrieval data to the one or more servers, the first controller being further configured to send a timer reset signal or buoy release signal to the one or more tracking units; and the second controller is configured to determine a deployment time using the one or more sensors and is configured to begin a timer for a set period of time in response to the deployment, and wherein upon the timer reaching zero or receiving a buoy release command the second controller is configured to operate the release mechanism to deploy the buoy to the surface; and wherein the second controller is configured to reset the timer in response to receiving a timer reset signal.

In some embodiments, the second controller and the wireless transceiver of the tracking unit are each disposed within or attached to the releasable buoy such that they are sent to the surface upon deployment of the buoy, and wherein the second controller is further configured to emit a beacon signal to assist in its location and retrieval once at the surface.

In some embodiments, the system further comprising one or more tagging units the one or more tagging units each comprising a power source, one or more sensors, a wireless transceiver, and a third controller configured to communicate with the first controller and/or the second controller to log deployment and retrieval location data for an associated trap and to carry out the same functions as the tracking units minus the use of a releasable buoy.

Furthermore, the sensors of each of the tracking units and/or tagging units may comprise a collision sensor, and the deployment time is determined in response to determining that a collision with the water has occurred.

In some embodiments, the system further comprises a floating relay communications vessel comprising a float, a wireless transceiver, and a fourth controller, the relay communications vessel being coupled to the one or more tracking units and configured to relay communications between the first controller and the second controller.

In some embodiments, the second controller of the tracking units is configured to communicate with the first controller and cause the units to enter a low power mode or turn off upon retrieval.

In some embodiments, one or more of the tracking units comprises connecting means for affixing the unit to a low tech trap.

In some embodiments, one or more of the tracking units are integrated with a smart trap apparatus and the buoy comprises a smart float having a cable reel, a number of buoyancy balls, a fishing ring, a wireless module, a base, and a shell.

The information recorded by the smart trap and conveyed to the first controller may include one or more of the type, number, and so forth of creatures in the cage, biometric information for captured creatures, the consumption of bait in the cage, depth, change in depth, and water pressure.

The information transmitted from the trap to the communications may also include one or more of: a trap identifier, location information, time, and date.

In some embodiments, the fishing vessel comprising means for deploying and retrieving fishing traps from the sea surface.

In some embodiments, the system further comprising one or more user devices configured to access the recorded tracking and retrieval data from the one or more servers.

In some embodiments, the one or more servers are configured to apply a data model to the deployment and retrieval data stored on them in order to assist fishing vessels in determining retrieval routes.

In some embodiments, the model is a machine learning model.

In some embodiments, the one or more sensors comprise one or more of sensors optical, sonar, pressure, and depth sensors.

In some embodiments, the wireless transceivers comprise one or more of sonar, 4G, 5G,

GPS transceivers.

In some embodiments, the buoy release is mechanical. In other embodiments, the buoy release is electrical.

### BRIEF DESCRIPTION OF THE DRAWINGS

Various embodiments of the invention are disclosed in the following detailed description and accompanying drawings.

FIG. 1 illustrates a block diagram of a first example configuration of the system which utilises smart trap units having integrated electronics and a floating relay vessel at the surface to communicate with a fishing vessel.

FIG. 2 illustrates a block diagram of an example smart trap configuration for use within the system of FIG. 1.

FIG. 3 illustrates a block diagram of an example smart float configuration for use within the system of FIG. 1.

FIG. 4 illustrates an isometric view of an example configuration of a companion unit comprising a releasable buoy which is affixed to a low-tech trap for use in an alternative system.

FIG. 5 illustrates an isometric view of an example configuration of a companion unit comprising a releasable buoy.

FIG. 6 illustrates an isometric view of an example configuration of a plurality of companion units affixed to a line of traps below the surface and in communication with a fishing vessel at the surface, one of the companion units comprising a releasable buoy.

FIG. 7 illustrates the configuration of FIG. 5 wherein the companion unit comprising the releasable buoy has deployed the buoy to the surface in response to a command signal or a timer running out.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The system of the present disclosure provides a smart underwater trapping system which can allow communication between a set of submerged traps or companion units having releasable buoys and users onboard a vessel at the sea surface, facilitating both tracking and retrieval of the traps as well as various other functionality.

A primary objective of the system is to reduce the amount of abandoned, lost, or discarded fishing gear (ALDFG) through enhanced traceability and supervision of lobster traps, leading to less wastage and damage of ecosystems.

Another objective of the disclosed system is to provide underwater trapping gear for lobsters and other sea creatures that does not need to have ropes deployed until collection. This reduces the chance of wildlife being caught and entangled in the ropes during deployment.

The system may comprise smart traps which themselves have integrated communications and processing circuitry, and may also comprise a number of trap companion units affixed to the a set of low-tech traps to provide said circuitry. The system incorporates releasable submerged buoys in both the smart traps and the trap companion units, which assist with retrieval of the traps, and also incorporates a communication system between the traps/units and a controller onboard a vessel deploying the traps which uploads related data to a server or cloud network architecture for monitoring and tracking the deployment and retrieval of the traps.

The system increases the visibility of trap management and thus facilitates supervision of fishing activities via a computerised protocol which logs trap deployment, retrieval, and ALDFG losses in a centralised database, increasing accountability of the parties responsible and thus reducing the risk of increased ALDFG accumulation. The system thus also drastically reduces the impact of marine litter in the ocean environment, with a strong audit trail to inspire quick reaction and promote awareness and involvement in support of marine ecosystem conservation.

The submerged releasable buoys of the units and smart traps unlock a range of applications including timed retrieval, gear tracking, and reduced time of deployed cables and ropes floating in water.

Two embodiments of the disclosed system are described herein. A first embodiment wherein the system is implemented as a set of smart traps having integrated releasable buoys and where the capabilities of the smart traps themselves are emphasised, and a second embodiment where the system is implemented as a set of companion units affixed to more traditional low-tech traps, and where the deployment and retrieval mechanisms from a fishing vessel are emphasised.

It should be noted that the two embodiments are not mutually exclusive, and that the system could additionally be implemented with a mixture of smart integrated traps and companion units.

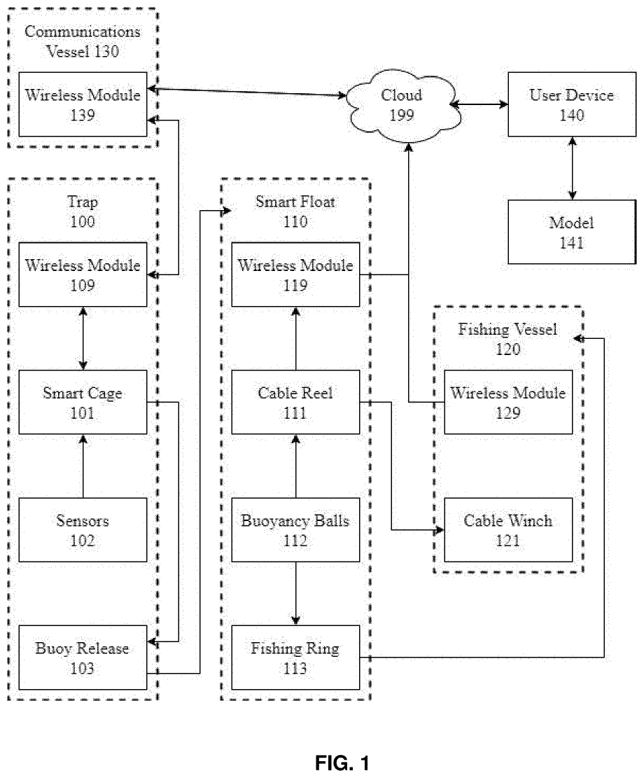

Thus, referring to the first embodiment as illustrated with respect to FIGS. 1-3. The underwater trapping system comprises a number of lobster traps, a smart releasable buoy system, a fishing vessel, a communications module, a user device, and a model. The term “trap” as used herein may refer to a companion unit affixed to a trap having its own communications and control circuitry or to a smart trap with such circuitry integrated into it.

A trap may record information from various sensors and communicate with a communications vessel. In examples where the trap is a smart trap comprising its own circuitry, it may send a buoy release command to an associated smart float, which will release one or more buoyancy balls that are attached to the base of the trap via a cable, and communicate the location information to the cloud. The trap may be a lobster trap or may be designed to catch other types of marine life or crustaceans.

A fishing vessel may retrieve the trap via the cable, redeploy the traps, and record the information data to upload to the cloud. The communications vessel can communicate with traps to send and receive various information and commands, and upload and retrieve data from the cloud. The user device may upload and receive various information from the cloud, and additionally communicates with the model. The model may work with the information uploaded to the cloud.

Referring to FIG. 1, a block diagram of an exemplary embodiment of the smart underwater trapping system is shown, including: a number of traps 100, each trap comprising a smart cage 101, a number of sensors 102, a buoy release 103, and a wireless module 109; a smart buoy system 110, comprising a cable reel 111, a number of buoyancy balls 112, a fishing ring 113, and a wireless module 119; a fishing vessel 120, including a cable winch 121, and a wireless module 129; a communications vessel 130, including a wireless module 139; a user device 140, and a model 141. The disclosed system utilizes the cloud 199, or at least a network architecture of some sort.

Information and commands are sent to and from the trap to the communications vessel via wireless modules. The wireless modules may be sonar, radio, or other suitable types. The information sent to the communications vessel by the trap may include identifier, location, time, date, depth, water pressure, number of creatures, status of bait, biometric information, and so forth. The information and commands received by the trap from the communications vessel may include location, time, date, buoy release, time to release float, and so forth. The information sent to the buoy release by the smart trap may be a buoy release command.

The buoy release may be triggered by: a buoy release command received from an external device via sonar communications or otherwise, long deployment periods causing a timer circuitry of the trap to release the buoy of its own accord, biometric information; low battery below a threshold level, and other suitable mechanisms.

When one trap is deployed from the fishing vessel, the wireless module on the trap communicates with the wireless module on the fishing vessel to record information. The information may include the identifier, location information, time, date, and so forth. The information may be uploaded to the cloud. The fishing vessel may use a cable winch to retrieve the trap via the cable attached to the smart buoy. The cable winch may be mechanical, electric, and so forth.

The communications vessel may be equipped with a wireless module and function as a two-way relay for signals received from submerged traps. The communications vessel is thus deployed in the area the traps were released. The communications vessel is able to retrieve information provided by the trap and upload it to the cloud. The communications vessel is able to receive information from the cloud and send it to the trap, such as for example a buoy release command as decided by a user. The buoy release command may be immediate or timed.

At various times the user device may receive: sensor, identifier, location information, time, date, and so forth from the smart cage; identifier, location information, time, date, and so forth from the smart float; identifier, location information, time, date and so forth from the fishing vessel. The user device can inform the communications vessel to give a command to release the buoy in specified traps.

The model is in some examples a data processing model which can optimize the route of the fishing vessel.

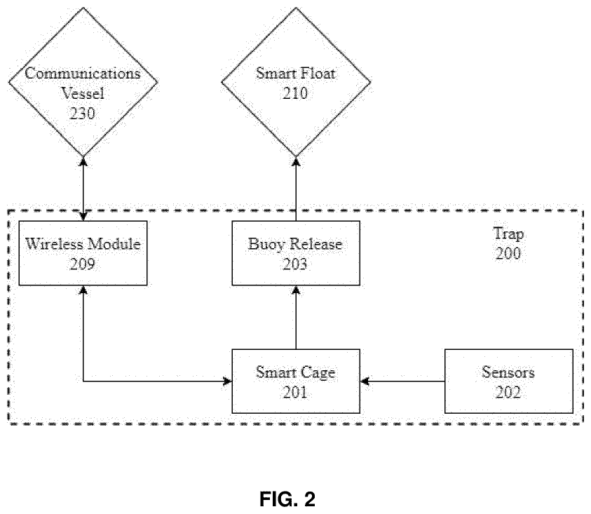

Referring to FIG. 2, a block diagram of an example embodiment of a smart trap 200 with integrated circuitry is shown, the smart trap comprising: a smart cage 201, a sensor 202, a buoy release 203, and a wireless module 209.

The smart cage, in addition to the features of a normal trapping cage, is able to record entry of creatures into the cage, dispense bait, send and receive information, and send and receive commands. The smart cage can send information, receive information, and receive commands via the wireless module, and send commands to the buoy release mechanism.

The sensors may be set to identify the type, number, etc of creatures in the cage, the consumption of bait in the cage, depth, change in depth, and water pressure. The sensors can feed the data to the smart cage. The buoy release can receive commands from the smart cage to release the smart float.

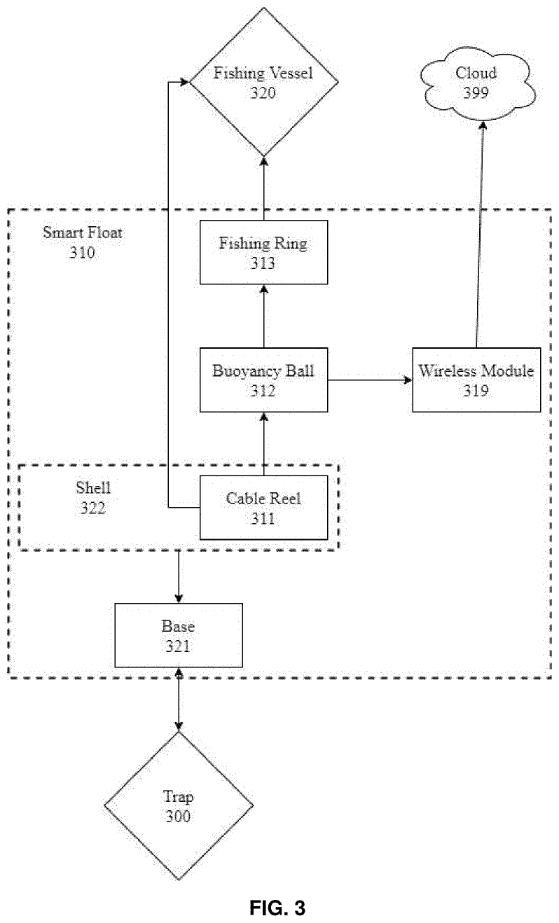

Referring to FIG. 3, a block diagram of an example embodiment of a smart releasable buoy 310 is shown which comprises: a cable reel 311, a number of buoyancy balls 312, a fishing ring 313, a wireless module 319, a base 321, and a shell 322. The smart buoy is securely attached to the trap via the base and may release the buoyancy balls via the buoy release. The shell protects the cable reel from biofouling. The buoyancy balls are attached the cable reel which unwinds to remain attached to the buoyancy balls. Upon reaching the surface, the wireless module communicates to the cloud the identifier, location information, time, date, and so forth. The fishing ring is attached to the buoyancy balls to allow the fishing vessel to retrieve the float.

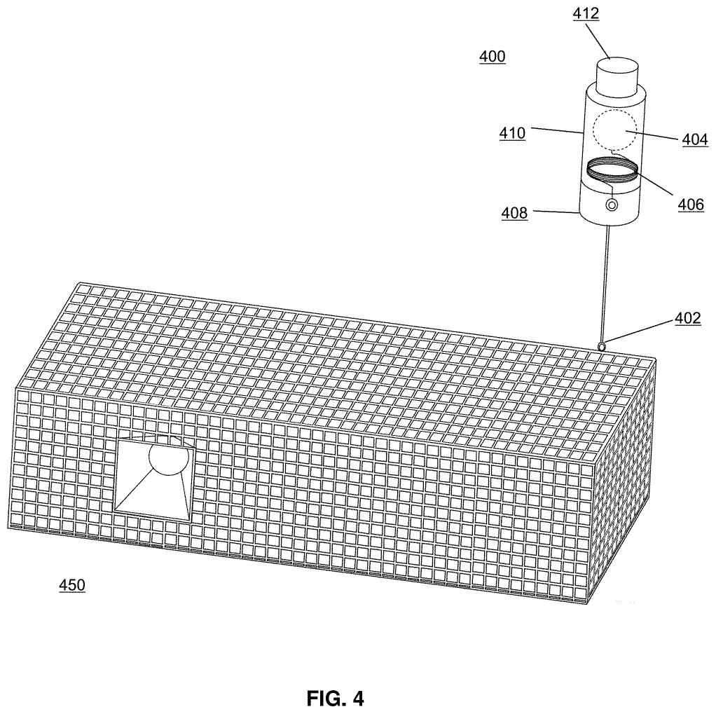

A second embodiment of the disclosed system will now be described with reference to FIGS. 4-7, wherein in place of smart trap units, one or more companion units having similar circuitry to the smart traps are affixed to one or more corresponding low-tech traps.

The system of the second embodiment thus comprises a number of lobster trap tracking units and a number of lobster trap tagging units working in tandem while in communication with a fishing vessel.

The lobster trap companion devices may be divided into a number of “tracking units” and a number of “tagging units” attached to the various lobster traps, which will be set out in the sea and checked or retrieved periodically by the fishing vessel.

A “tracking unit” as referred to herein means a lobster trap companion device comprising a submerged buoy and an electrical operating system which will release the submerged buoy after a set amount of time unless deactivated by a signal received from a “deck unit” located on a fishing vessel.

A “tagging unit” as referred to herein means a lobster trap companion similar in construction to the lobster trap companion of the “tracking units” but without the ability to release a buoy.

Referring to FIG. 4, an example configuration of a tracking unit 400 is shown attached to a traditional low-tech lobster trap 450.

The example tracking unit 400 shown comprises attachment means 402 to attach to a respective lobster trap and further comprise a releasable buoy 404 held within a sealed chamber (illustrated transparently for the purposes of explanation), with a thin line 406 connecting the buoy 404 to the companion once released. The housing of the companion unit 400 is formed of a first lower portion 408 and a second upper portion 410 which are held together by a release mechanism such as a seal and clip.

A battery or other power source, a wireless module, a timer, and “collision sensor” are held in a second sealed chamber 412 attached to the top portion. The tracking units can also comprise GPS modules and other sensors as described below.

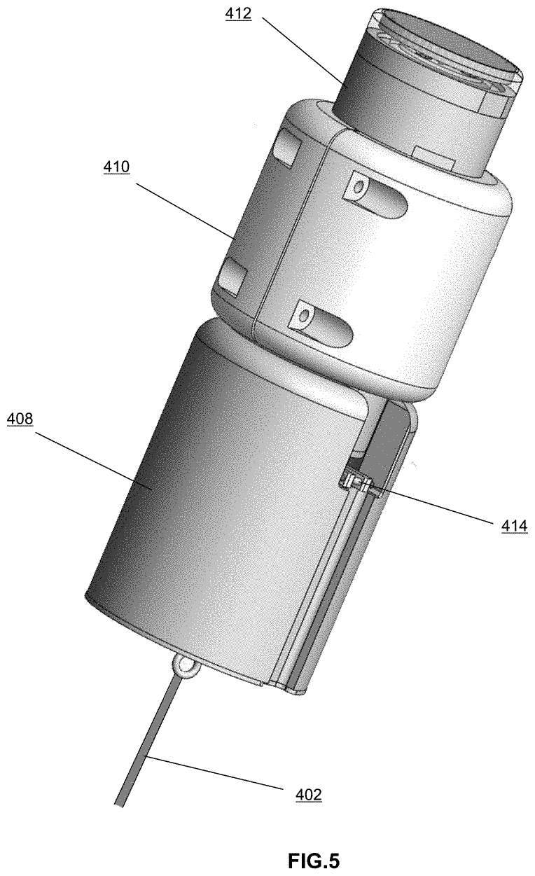

An example construction of the housing is shown in more detail in FIG. 5, with a release mechanism 414 for detaching the upper portion 410 from the lower portion 408 also shown.

When the buoy 404 is released to the surface, the release mechanism separates the lower portion 408 from the upper portion 410, allowing the upper portion 410 including the buoy 404 and the associated electronics held in sealed chamber 412 to rise away from the trap 450 and the attached lower portion 408 to the surface, with the coiled reel of thing line 406 unwinding completely.

While example configurations of the structure of the companion units and releasable buoys are provided herein, it should be noted that other suitable configurations may also be used in their stead. For example, various example configurations of suitable buoy release mechanisms and control circuitry are provided in the applicant's co-pending application CA3038171A1, the content of which is incorporated by reference herein in its entirety.

The tagging units are structured very similarly to the lobster trap companion tracking units but without the releasable buoys and lines. They are thus lower cost while still providing tracking capabilities for the trap they are attached to, should that trap be separated from a group of traps.

In the implementation of the disclosed system, individual lobster traps or groups of lobster traps will be tagged with at least one tracking unit that will update the onboard system of the vessel in real time on the status of each lobster trap or group of lobster traps via wireless communication.

The system may be comprised of any combination of tracking units and tagging units to accommodate different types of fishing practice, vessels, and environmental conditions. For example, the system may be comprised of a single tracking unit for each individual lobster trap.

If groups of traps are deployed together as is often the case, only one tracker unit with a deployable buoy may be necessary, and the rest of the traps, being in close proximity, can be fitted with the simpler and more cost-effective tagging units. Thus, an alternative configuration of the system is to have a group or line of traps with one trap fitted with a tracker unit and the remaining (3, 4, 5, 6, etc) traps in the line each fitted with a tagger unit.

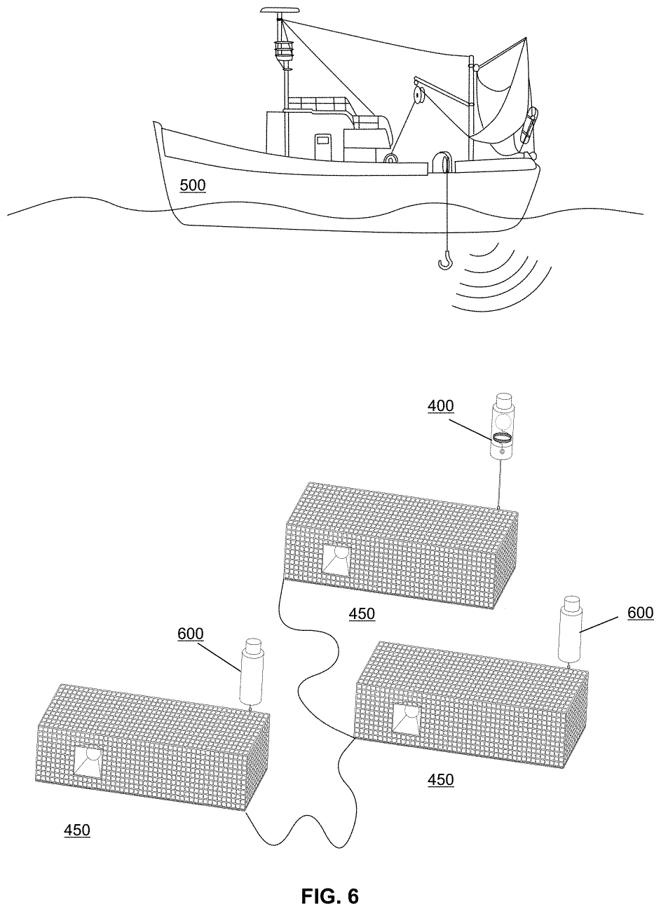

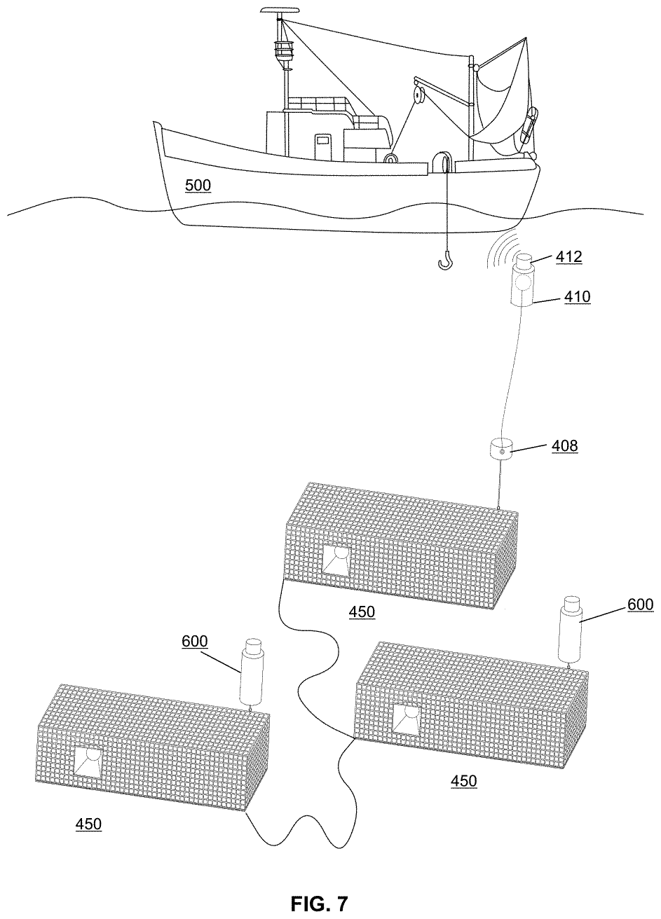

Such a configuration is shown with reference to FIGS. 6 and 7, with a fishing vessel 500 shown on the surface and in communication with a set of submerged units, including one tracker unit 400 having a releasable buoy 404 and a pair of tagger units 600 attached to their own respective traps 450.

The vessel controller and indeed the controllers of each of the units affixed to the traps may be in communication with a network which logs and tracks related data for the various units. Every time a trap is deployed or retrieved by a fisherman to replace bait and remove catch, the unit associated with that trap will automatically connect with a shipboard controller which will record and transmit tracking information (such as location, status, time, etc.) to this network.

This allows for continuous automatic recording of fishing activities, as well as tracking of traps via an easily accessible internet platform, without requiring change in current industry practices.

An example implementation of the system, i.e. the use of trackers, taggers, wireless modules, and fishing vessel deck unit to deploy, track, and retrieve a set of traps will now be described.

At the deployment stage, a set of traps such as lobster traps are each affixed with a corresponding unit, with at least one unit of the set being a tracking unit. The various units are in communication with a deck unit of the fishing vessel from which they are being deployed. Each unit in the set may have an associated ID number used in communication signals for identifying the monitored trap to which it is affixed.

When the traps 450 are released from the vessel 500 and collide with the water, the collision sensor of each unit will inform the computing unit located on the vessel that the trap has been released at that time and location (either using the GPS functionality of the vessel or that of the units themselves if they are equipped with GPS sensors).

Simultaneously, the collision detection will cause the controller of each unit to start a timer. Once the timer reaches zero the system will assume that the unit and trap it is affixed to has been lost.

Referring to FIG. 7, the unit will in response to that determination take actions to assist with location and retrieval of the trap by either broadcasting a beacon signal or the tracking units releasing their submerged buoys 404, which are usually brightly coloured to increase visibility, to the sea surface for direct visual identification.

The beacon signal can both serve to locate the “lost” trap and also to notify a user of the loss. Related data for the unit such as last known GPS location, trap or unit ID, deployment location, and deployment time may also be sent along with the signal and will in some examples be able to be accessed via a cloud-based digital mapping platform. When the lost lobster trap is retrieved using this related data to approximate location, the releasable buoy will be found within visible distance. At this point a Remotely Operated Underwater Vehicle (ROV) can be deployed to inspect conditions surrounding lobster traps on the seafloor.

In some cases, it may be desirable to delay retrieval of the traps past the point of the end of the timer. For example, if it is known that the trap is still in place and functioning, but no catch has been made, it may be more efficient to simply reset the timer. Thus, the shipboard system may be configured to communicate with the trap and automatically reset the timer module of the tracking/tagging unit when it is in range. This way, instead of needing to retrieve and reset the timer's onboard the vessel each time, the vessel can simply make a pass within communication range and start the clock ticking from zero again.

When a trap is retrieved the associated unit will communicate with the onboard vessel system, i.e. to determine the proximity, and will turn off or enter a low power mode.

The emergency mechanisms outlined above: the submerged releasable buoy equipped on the tracker units; and the alarm signal sent out to the fishing vessel after a pre-set time; ensure a built-in method to provide prompt and accurate ALDFG reports to license holders if the gear breaks from its rope tie, with time, location, and GPS coordinates information relayed.

The automated real-time alerts allow fishermen to respond quickly to lost traps which benefits them financially both by reducing the amount of lost gear and the amount of time during which traps are non-operational.

The initial deployment of the system can be supported by telecommunications trackers and ROVs which are minimally invasive, but powerful tools that proactively manage fishing gear in the prevention against abandonment and loss.

It should be understood that the operations described herein, in particular those described as being carried out by a cloud, network architecture, or one or more servers hosting the digital platform through which trap deployment retrieval and tracking data is stored and accessed may be carried out by any processor.

In particular, the operations may be carried out by, but are not limited to, one or more computing environments used to implement the method such as a data center, a cloud computing environment, a dedicated hosting environment, and/or one or more other computing environments in which one or more assets used by the method re implemented; one or more computing systems or computing entities used to implement the method; one or more virtual assets used to implement the method; one or more supervisory or control systems, such as hypervisors, or other monitoring and management systems, used to monitor and control assets and/or components; one or more communications channels for sending and receiving data used to implement the method; one or more access control systems for limiting access to various components, such as firewalls and gateways; one or more traffic and/or routing systems used to direct, control, and/or buffer, data traffic to components, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the method; one or more databases used to store data; one or more internal or external services used to implement the method; one or more backend systems, such as backend servers or other hardware used to process data and implement the method; one or more software systems used to implement the method; and/or any other assets/components in which the method is deployed, implemented, accessed, and run, e.g., operated, as discussed herein, and/or as known in the art at the time of filing, and/or as developed after the time of filing.

The trap data monitoring and deployment tracking platform may be accessed by a wireless device which may be a mobile handset, mobile phone, wireless phone, portable cell phone, cellular phone, portable phone, a personal digital assistant (PDA), a tablet, a portable media device, a wearable computer, or any type of mobile terminal which is regularly carried by an end user and has all the elements necessary for operation in a wireless communication system. The wireless communications include, by way of example and not of limitation, CDMA, WCDMA, GSM, UMTS, or any other wireless communication system such as wireless local area network (WLAN), Wi-Fi or WiMAX.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

As used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

Unless specifically stated otherwise, as would be apparent from the above discussion, it is appreciated that throughout the above description, discussions utilizing terms such as, but not limited to, “activating”, “accessing”, “adding”, “applying”, “analyzing”, “associating”, “calculating”, “capturing”, “classifying”, “comparing”, “creating”, “defining”, “detecting”, “determining”, “eliminating”, “extracting”, “forwarding”, “generating”, “identifying”, “implementing”, “obtaining”, “processing”, “providing”, “receiving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the tracking and retrieval system have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system for monitoring and retrieval of one or more fishing traps, the system comprising:
a fishing vessel, the fishing vessel comprising a wireless transceiver and a first controller;
one or more tracking units, the one or more tracking units comprising a power source, one or more sensors, a wireless transceiver, a buoy connected to an associated fishing trap by a coiled reel, a release mechanism for deploying the buoy and reel, and a second controller; and
one or more servers in wireless communication with the first controller and configured to record and log fishing trap management data received from the fishing vessel;
wherein the first controller of the fishing vessel is configured to record deployment and retrieval data from the one or more tracking units, including time and location data of trap deployment, and to upload the deployment and retrieval data to the one or more servers, the first controller being further configured to send a timer reset signal or buoy release signal to the one or more tracking units;
and wherein the second controller is configured to determine a deployment time using the one or more sensors and is configured to begin a timer for a set period of time in response to the deployment, and wherein upon the timer reaching zero or receiving a buoy release command the second controller is configured to operate the release mechanism to deploy the buoy to the surface; and wherein the second controller is configured to reset the timer in response to receiving a timer reset signal.

2. A system according to claim 1, wherein the second controller and the wireless transceiver of the tracking unit are each disposed within or attached to the releasable buoy such that they are sent to the surface upon deployment of the buoy, and wherein the second controller is further configured to emit a beacon signal to assist in its location and retrieval once at the surface.

3. A system according to claim 1, the system further comprising one or more tagging units the one or more tagging units each comprising a power source, one or more sensors, a wireless transceiver, and a third controller configured to communicate with the first controller and/or the second controller to log deployment and retrieval location data for an associated trap and to carry out the same functions as the tracking units minus the use of a releasable buoy.

4. A system according to claim 3, wherein the sensors of each of the tracking units and/or tagging units comprise a collision sensor, and the deployment time is determined in response to determining that a collision with the water has occurred.

5. A system according to claim 1, wherein the system further comprises a floating relay communications vessel comprising a float, a wireless transceiver, and a fourth controller, the relay communications vessel being coupled to the one or more tracking units and configured to relay communications between the first controller and the second controller.

6. A system according to claim 1, wherein the second controller of the tracking units is configured to communicate with the first controller and cause the units to enter a low power mode or turn off upon retrieval.

7. A system according to claim 1, wherein one or more of the tracking units comprises connecting means for affixing the unit to a low tech trap.

8. A system according to claim 1, wherein one or more of the tracking units are integrated with a smart trap apparatus and the buoy comprises a smart float having a cable reel, a number of buoyancy balls, a fishing ring, a wireless module, a base, and a shell.

9. A system according to claim 8, wherein the information recorded by the smart trap and conveyed to the first controller includes one or more of the type, number, and so forth of creatures in the cage, biometric information for captured creatures, the consumption of bait in the cage, depth, change in depth, and water pressure.

10. A system according to claim 8, wherein the information transmitted from the trap to the communications includes one or more of: a trap identifier, location information, time, and date.

11. A system according to claim 1, the fishing vessel comprising means for deploying and retrieving fishing traps from the sea surface.

12. A system according to claim 1, the system further comprising one or more user devices configured to access the recorded tracking and retrieval data from the one or more servers.

13. A system according to claim 1, wherein the one or more servers are configured to apply a data model to the deployment and retrieval data stored on them in order to assist fishing vessels in determining retrieval routes.

14. A system according to claim 1, wherein the model is a machine learning model.

15. A system according to claim 1, wherein the one or more sensors comprise one or more of sensors optical, sonar, pressure, and depth sensors.

16. A system according to claim 1, wherein the wireless transceivers comprise one or more of sonar, 4G, 5G, GPS transceivers.

17. A system according to claim 1, wherein the buoy release is mechanical.

18. A system according to claim 1, wherein the buoy release is electrical.
